(19) United States
(12) Patent Application Publication
(10) Pub. No.: US 2026/0217327 A1
(43) Pub. Date: Jul. 30, 2026

(54) CONTROL SYSTEM

(71) Applicant: TOYOTA JIDOSHA KABUSHIKI KAISHA, Toyota-shi (JP)

(72) Inventors: Hiroya CHIBA, Fuji-shi (JP); Kento Iwahori, Nagoya-shi (JP); Kazuki Egashira, Susono-shi (JP); Yuhei Oka, Susono-shi (JP); Ryuji Okamura, Gotemba-shi (JP); Yuki Okamoto, Ebina-shi (JP); Amane Yajima, Ashigarakami-gun (JP); Takahiro Yokota, Susono-shi (JP)

(73) Assignee: TOYOTA JIDOSHA KABUSHIKI KAISHA, Toyota-shi (JP)

(21) Appl. No.: 19/443,431

(22) Filed: Jan. 8, 2026

(30) Foreign Application Priority Data
Jan. 28, 2025 (JP) 2025-011861

(51) Int. Cl. B62D 65/18; G05B 13/02

(52) U.S. Cl. CPC B62D 65/18; G05B 13/026

(57) ABSTRACT

In a control system that controls an open-close state of equipment whose open-close state is changeable, the equipment is installed to a moving object that is movable by unmanned driving. The control system includes a sensor, a detection unit, a prediction unit, and a control unit. The sensor detects the moving object from outside of the moving object. The detection unit uses a detection result of the sensor to detect the open-close state of the equipment. When the detection unit detects that the open-close state of the equipment is an open state, the prediction unit predicts whether the moving object will have a trouble with moving by the unmanned driving due to the open-close state of the equipment being the open state. When the prediction unit predicts that the trouble occurs, the control unit executes specific processing to eliminate the trouble.

### CROSS-REFERENCE TO RELATED APPLICATIONS

This application claims priority to Japanese Patent Application No. 2025-011861 filed on January 28, 2025, which is incorporated herein by reference in its entirety.

### BACKGROUND

### Field

The present disclosure relates to a control system.

### Related Art

Conventionally, known vehicles run by unmanned driving (Japanese Translation of PCT International Application Publication No. JP-T-2017-538619).

A moving object, such as a vehicle, is mounted with various types of equipment, such as a hood, a lid, a door, and a window, whose open-close states are changeable. In production of the moving object, the open-close state of the equipment may be made an open state in order to accomplish a specific purpose, such as work or inspection to the moving object. Further, in use of the moving object, the open-close state of the equipment may be made the open state in order to accomplish a specific purpose, such as getting on or off, power source refilling, inspection, or repair with respect to the moving object. However, when a user forgets to close the equipment, or when operation to open or close the equipment by the user is insufficient after accomplishment of the specific purpose, the open-close state of the equipment may be kept the open state even after the accomplishment of the specific purpose. When the open-close state of the equipment is kept the open state even after the accomplishment of the specific purpose, the moving object may have a trouble with moving by unmanned driving.

### SUMMARY

The present disclosure is achievable as the following aspects.

According to one aspect of the present disclosure, a control system is provided. In a control system that controls an open-close state of equipment whose open-close state is changeable, the equipment is installed to a moving object that is movable by unmanned driving. The control system includes a sensor, a detection unit, a prediction unit, and a control unit. The sensor detects an external shape of the moving object from outside of the moving object. The detection unit uses a detection result of the sensor to detect the open-close state of the equipment. When the detection unit detects that the open-close state of the equipment is an open state, the prediction unit predicts whether the moving object will have a trouble with moving by the unmanned driving due to the open-close state of the equipment being the open state. When the prediction unit predicts that the trouble occurs, the control unit executes specific processing to eliminate the trouble.

### BRIEF DESCRIPTION OF THE DRAWINGS

FIG. 1 is a conceptual diagram illustrating a configuration of a control system according to a first embodiment;

FIG. 2 is a block diagram illustrating a configuration of a control system;

FIG. 3 is a flowchart illustrating a procedure of running control of a vehicle according to the first embodiment;

FIG. 4 is a flowchart illustrating a control method according to the first embodiment;

FIG. 5 is a flowchart illustrating a control method according to a second embodiment;

FIG. 6 is a flowchart illustrating a control method according to a third embodiment;

FIG. 7 is an explanatory diagram illustrating a schematic configuration of a control system according to a fourth embodiment; and

FIG. 8 is a flowchart illustrating a procedure of running control of a vehicle according to the fourth embodiment.

### DETAILED DESCRIPTION

### A. First Embodiment:

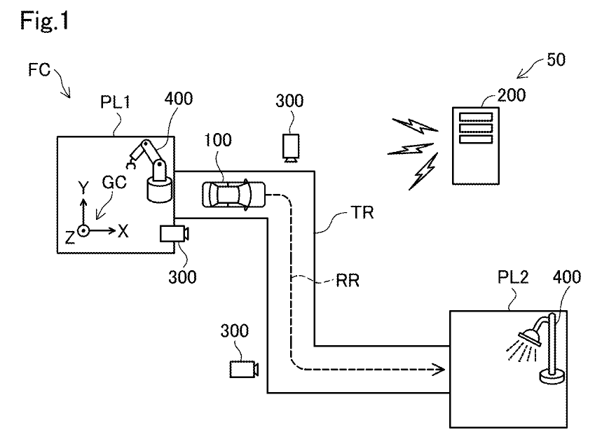

FIG. 1 is a conceptual diagram illustrating a configuration of a control system 50 according to a first embodiment. The control system 50 includes one or more vehicles 100 as a moving object, a server 200, and one or more external sensors 300.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, or a construction vehicle for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

In this embodiment, the control system 50 is used in a factory FC where the vehicle 100 is produced through execution of a plurality of production steps. A reference coordinate system in the factory FC is a global coordinate system GC, and any position in the factory FC can be represented by X, Y, and Z coordinates in the global coordinate system GC. The factory FC includes a first place PL1 and a second place PL2. In each of the places PL1 and PL2, for example, one or more actual steps, such as an assembly step and an inspection step, are executed among the plurality of production steps. The first place PL1 and the second place PL2 are connected to one another through a track TR on which the vehicle 100 is runnable. The vehicle 100 moves from the first place PL1 to the second place PL2 through the track TR by unmanned driving. On the track TR, a transport step in which the vehicle 100 is transported from the first place PL1 to the second place PL2 is executed among the plurality of production steps. Note that the configuration of the factory FC is not limited to that described above. At least one of the first place PL1 and the second place PL2 may be, for example, a storage site such as a yard where the vehicle 100 is stored.

In the factory FC, a plurality of external sensors 300 is disposed along the track TR. A position of each external sensor 300 in the factory FC is adjusted in advance. The external sensor 300 is a sensor located outside of the vehicle 100. The external sensor 300 in this embodiment is a sensor that detects the vehicle 100 from outside of the vehicle 100. The external sensor 300 includes a communication device (not illustrated) and can communicate with another device, such as the server 200, by wired or wireless communication. In this embodiment, the external sensor 300 includes a camera. The camera as the external sensor 300 captures an image of the vehicle 100 and outputs the captured image as a detection result.

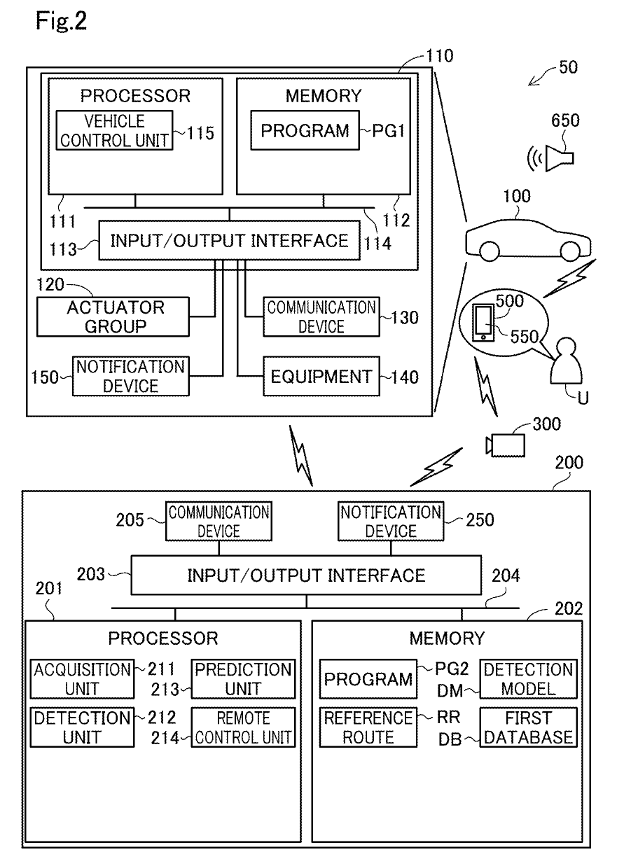

FIG. 2 is a block diagram illustrating a configuration of the control system 50. The vehicle 100 includes a vehicle control device 110 that controls each unit of the vehicle 100, an actuator group 120 including one or more actuators that perform driving under control of the vehicle control device 110, and a communication device 130 to communicate with an external device, such as the server 200, by wireless communication. The actuator group 120 includes an actuator for a driving device to accelerate the vehicle 100, an actuator for a steering device to change a traveling direction of the vehicle 100, and an actuator for a braking device to decelerate the vehicle 100.

Moreover, the vehicle 100 is mounted with equipment 140 whose open-close state is changeable. Accordingly, the actuator group 120 further includes a specific actuator to change an open-close state of the equipment 140. In this embodiment, the equipment 140 is a component that affects an external shape of the vehicle 100, that is, a contour of the vehicle 100, and is, for example, a hood that separates an inside and an outside of an engine room or a motor room. The equipment 140 may be a boarding door, such as a front door or a rear door, that separates an inside and an outside of a cabin, a luggage compartment door, such as a back door, that separates an inside and an outside of a luggage compartment, a trunk lid that separates an inside and an outside of a trunk room, or a roof, such as a sunroof or a moonroof, that separates the inside and the outside of the cabin. Further, the equipment 140 may be a fuel lid that covers, in an openable and closable manner, a supply-port cap covering a supply port for fuel refilling, or may be a charging lid that covers, in an openable and closable manner, a charging plug for charging a battery installed to the vehicle 100.

The vehicle control device 110 includes a computer including a processor 111, a memory 112, an input/output interface 113, and an internal bus 114. The processor 111, the memory 112, and the input/output interface 113 are coupled to one another via the internal bus 114 in a bidirectionally communicable manner. The actuator group 120 and the communication device 130 are coupled to the input/output interface 113. The processor 111 executes a program PG1 stored in the memory 112, thus functioning as a vehicle control unit 115.

The vehicle control unit 115 controls the actuator group 120 to cause the vehicle 100 to run. The vehicle control unit 115 can use a running control signal received from the server 200 to control the actuator group 120, thereby causing the vehicle 100 to run. The running control signal is a control signal to cause the vehicle 100 to run. In this embodiment, the running control signal includes, as parameters, acceleration and a steering angle of the vehicle 100. In another embodiment, the running control signal may include, alternative to or in addition to the acceleration of the vehicle 100, speed of the vehicle 100 as a parameter. Further, in this embodiment, the vehicle control unit 115 uses a notification control signal received from the server 200 to control a notification device 150 installed to the vehicle 100, and thus notifies a user U of various kinds of information. The notification control signal is a control signal to control operation of notification devices 150, 250, 550, and 650.

The server 200 includes a computer including a processor 201, a memory 202, an input/output interface 203, and an internal bus 204. The processor 201, the memory 202, and the input/output interface 203 are coupled to one another via the internal bus 204 in a bidirectionally communicable manner. A communication device 205 to communicate with various devices outside of the server 200 is coupled to the input/output interface 203. The communication device 205 can communicate with the vehicle 100 by wireless communication and communicate with each external sensor 300 by wired or wireless communication. The processor 201 executes a program PG2 stored in the memory 202, thus functioning as an acquisition unit 211, a detection unit 212, a prediction unit 213, and a remote control unit 214.

The acquisition unit 211 acquires various kinds of information. In this embodiment, the acquisition unit 211 acquires various kinds of information including the captured image that is the detection result of the camera as the external sensor 300 and step information indicating a work step executed to the vehicle 100. For example, the acquisition unit 211 uses vehicle position information to acquire the step information. In this case, for example, the acquisition unit 211 collates a position of the vehicle 100 in the global coordinate system GC with a map indicating positions of the places PL1 and PL2, and TR in the factory FC in the global coordinate system GC, thereby identifying a production step currently executed to the vehicle 100. Then, the acquisition unit 211 identifies a production step to be executed after the production step currently executed to the vehicle 100 based on an execution order of a plurality of production steps, thereby acquiring the step information. Note that the method for acquiring the step information is not limited to that described above. For example, the acquisition unit 211 may utilize communication between the vehicle 100 and production equipment 400 installed in each of the places PL1 and PL2 where the production step is executed to acquire the step information.

The detection unit 212 uses the detection result of the sensor to detect the open-close state of the equipment 140. In this embodiment, the detection unit 212 analyzes the captured image in which the vehicle 100 is imaged, to detect the open-close state of the equipment 140. Note that the method for detecting the open-close state of the equipment 140 is not limited to that described above. For example, the detection unit 212 may use a detection result of an internal sensor, such as a camera, installed to another vehicle 100 to detect the open-close state of the equipment 140.

When the detection unit 212 detects that the open-close state of the equipment 140 is the open state, the prediction unit 213 predicts whether the vehicle 100 will have a trouble with running by unmanned driving due to the open-close state of the equipment 140 being the open state. "Having a trouble" is at least one of a case in which running by unmanned driving cannot be continued and a case in which running by unmanned driving can be continued while the running has a trouble of some kind, due to the open-close state of the equipment 140 being the open state. In this embodiment, the prediction unit 213 refers to a first database DB stored in the memory 202 in advance and indicating for each production step whether the vehicle 100 will have a trouble with running by unmanned driving. Then, the prediction unit 213 identifies in the first database DB whether the vehicle 100 will have a trouble with running by unmanned driving, which is associated with the production step identified by the step information, and thus predicts whether the vehicle 100 will have a trouble with running by unmanned driving. Note that the prediction method is not limited to that described above. For example, the prediction unit 213 may use the detection result of the sensor to recognize an environment around the vehicle 100, and thus predict whether the vehicle 100 will have a trouble with running by unmanned driving due to the open-close state of the equipment 140 being the open state.

The remote control unit 214 acquires the detection result of the sensor and uses the detection result to generate the running control signal to control the actuator group 120 of the vehicle 100. The remote control unit 214 then transmits the running control signal to the vehicle 100 to cause the vehicle 100 to run by remote control. Further, when the prediction unit 213 predicts that the vehicle 100 will have a trouble with running by unmanned driving, the remote control unit 214 executes specific processing to eliminate the trouble that will occur to the vehicle 100 running by unmanned driving. In this embodiment, the remote control unit 214 executes, as the specific processing, notification processing to notify the user U of error information indicating that occurrence of a trouble is predicted. At this time, for example, the remote control unit 214 notifies the user U via at least one of the notification device 150 of the vehicle 100, the notification device 250 of the server 200, the notification device 550 of a portable terminal 500 held by the user U, and the notification device 650 installed in the factory FC. In this embodiment, in the notification processing, the remote control unit 214 generates a notification control signal to sound a horn and transmits the notification control signal to the vehicle 100. The horn is installed to the vehicle 100 and generates warning sound. Accordingly, the remote control unit 214 causes the horn to sound by remote control, thereby notifying the user U of the error information. Note that the method for notifying the error information is not limited to that described above. For example, the remote control unit 214 may cause a lamp installed to the vehicle 100 to be turned on or to blink, or cause a wiper installed to the vehicle 100 to swing, thereby notifying the user U of the error information. Moreover, the remote control unit 214 may display text information on a display of the server 200 or the portable terminal 500 or a monitor installed in the factory FC, thereby notifying the user U of the error information. The remote control unit 214 may play audio information from a speaker of the server 200 or the portable terminal 500 or a speaker installed in the factory FC, thereby notifying the user U of the error information.

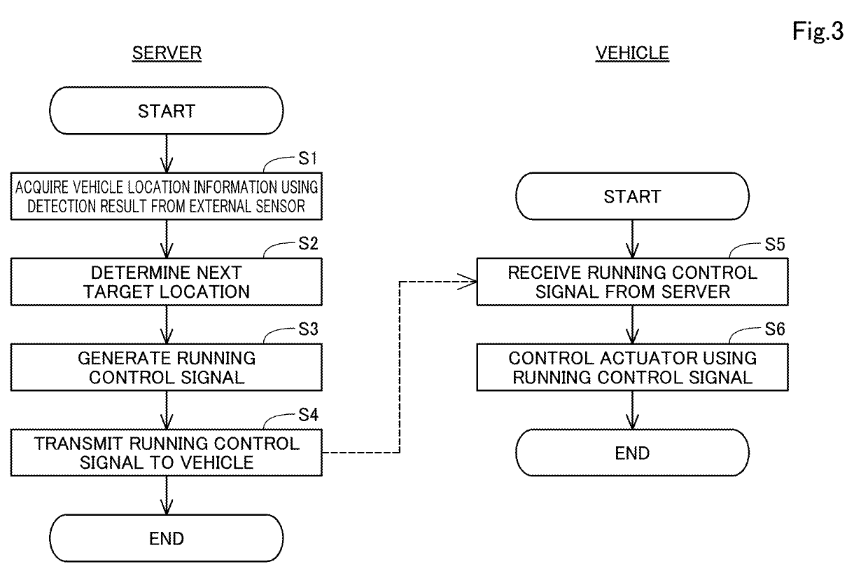

FIG. 3 is a flowchart showing a processing procedure for running control of the vehicle 100 in the first embodiment. In step S1, the processor 201 of the server 200 acquires vehicle location information using detection result output from an external sensor 300. The external sensor is located outside the vehicle 100. The vehicle location information is locational information as a basis for generating a running control signal. In the present embodiment, the vehicle location information includes the location and orientation of the vehicle 100 in a reference coordinate system of the factory FC. In step S1, the processor 201 acquires the vehicle location information using the captured image acquired from the camera as the external sensor 300.

More specifically, in step S1, the processor 201 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GC, thereby acquiring the location of the vehicle 100. The outer shape of the vehicle 100 in the captured image may be detected by inputting the captured image to a detection model DM using artificial intelligence, for example. The detection model DM is prepared in the control system 50 or outside the control system 50. The detection model DM is stored in advance in a memory 202 of the server 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model DM and the label. The processor 201 can acquire the orientation of the vehicle 100 through estimation based on the direction of a motion vector of the vehicle 100 detected from change in location of a feature point of the vehicle 100 between frames of the captured images using optical flow process, for example.

In step S2, the processor 201 of the server 200 determines a target location to which the vehicle 100 is to move next. In the present embodiment, the target location is expressed by X, Y, and Z coordinates in the global coordinate system GC. The memory 202 of the server 200 contains a reference route RR stored in advance as a route along which the vehicle 100 is to run. The route is expressed by a node indicating a departure place, a node indicating a way point, a node indicating a destination, and a link connecting nodes to each other. The processor 201 determines the target location to which the vehicle 100 is to move next using the vehicle location information and the reference route RR. The processor 201 determines the target location on the reference route RR ahead of a current location of the vehicle 100.

In step S3, the processor 201 of the server 200 generates a running control signal for causing the vehicle 100 to run toward the determined target location. The processor 201 calculates a running speed of the vehicle 100 from transition of the location of the vehicle 100 and makes comparison between the calculated running speed and a target speed of the vehicle 100 determined in advance. If the running speed is lower than the target speed, the processor 201 generally determines an acceleration in such a manner as to accelerate the vehicle 100. If the running speed is higher than the target speed as, the processor 201 generally determines an acceleration in such a manner as to decelerate the vehicle 100. If the vehicle 100 is on the reference route RR, server 200 determines a steering angle and an acceleration in such a manner as to prevent the vehicle 100 from deviating from the reference route RR. If the vehicle 100 is not on the reference route RR, in other words, if the vehicle 100 deviates from the reference route, the processor 201 determines a steering angle and an acceleration in such a manner as to return the vehicle 100 to the reference route RR.

In step S4, the processor 201 of the server 200 transmits the generated running control signal to the vehicle 100. The processor 201 repeats the acquisition of vehicle location information, the determination of a target location, the generation of a running control signal, the transmission of the running control signal, and others in a predetermined cycle.

In step S5, the processor 111 of the vehicle 100 receives the running control signal transmitted from the server 200. In step S6, the processor 111 of the vehicle 100 controls the actuator group 120 of the vehicle 100 using the received running control signal, thereby causing the vehicle 100 to run at the acceleration and the steering angle indicated by the running control signal. The vehicle 100 repeats the reception of a running control signal and the control over the actuator group 120 in a predetermined cycle. According to the control system 50 in the present embodiment, it becomes possible to move the vehicle 100 without using a transport unit such as a crane or a conveyor.

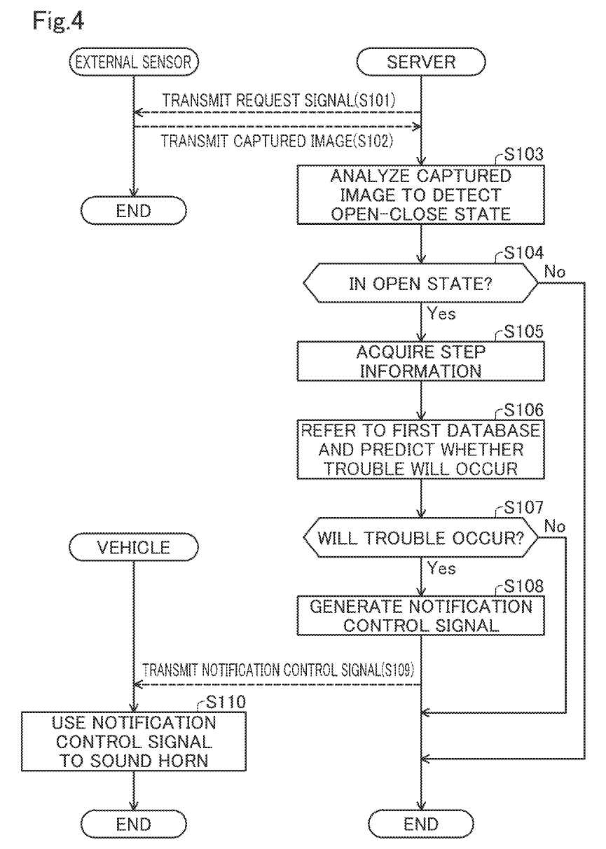

FIG. 4 is a flowchart illustrating a control method according to the first embodiment. For example, this control method is repetitively executed at a predetermined time period from a time point at which the vehicle 100 starts to run by unmanned driving. At Step S101, the acquisition unit 211 of the server 200 transmits to the camera as the external sensor 300 a request signal to acquire the captured image. In response to reception of the request signal, at Step S102, the external sensor 300 transmits to the server 200 the captured image in which the vehicle 100 is imaged. When the acquisition unit 211 of the server 200 acquires the captured image, at Step S103, the detection unit 212 of the server 200 analyzes the captured image to detect the open-close state of the equipment 140. If the detection unit 212 detects that the open-close state of the equipment 140 is the close state (Step S104: No), the server 200 ends this flow. If the detection unit 212 detects that the open-close state of the equipment 140 is the open state (Step S104: Yes), at Step S105, the acquisition unit 211 of the server 200 uses the vehicle position information to acquire the step information. At Step S106, the prediction unit 213 of the server 200 refers to the first database DB and predicts based on the step information whether the vehicle 100 will have a trouble with running by unmanned driving. If the prediction unit 213 predicts that the vehicle 100 will not have a trouble with running by unmanned driving (Step S107: No), the server 200 ends this flow. If the prediction unit 213 predicts that the vehicle 100 will have a trouble with running by unmanned driving (Step S107: Yes), at Step S108, the remote control unit 214 of the server 200 generates the notification control signal to sound the horn of the vehicle 100. At Step S109, the remote control unit 214 transmits the generated notification control signal to the vehicle 100. In response to reception of the notification control signal, at Step S110, the vehicle control unit 115 of the vehicle 100 uses the received notification control signal to sound the horn.

According to the first embodiment, the vehicle 100 is mounted with equipment 140, such as a hood, a trunk lid, various types of doors including a boarding door and a luggage compartment door, and a roof, whose open-close states are changeable. In production of such a vehicle 100, the open-close state of the equipment 140 may be made the open state in order to accomplish a specific purpose, such as assembly or inspection of a component. For example, a hood may be opened in order to check an inside of an engine room or a motor room. A boarding door may be opened in order to perform work inside a cabin. A luggage compartment door, a trunk lid, or a roof may be opened in order to check open-close operation. A fuel lid or a charging lid may be opened in order to refill a power source, for example, fuel or electric power, of the vehicle 100. However, after accomplishment of such a specific purpose, when the user U forgets to close the equipment 140, or operation to open or close the equipment 140 by the user U is insufficient, the open-close state of the equipment 140 may be kept the open state even after the accomplishment of the specific purpose. When the open-close state of the equipment 140 is kept the open state even after the accomplishment of the specific purpose, the vehicle 100 may have a trouble with running by unmanned driving. For example, in the first embodiment, in order to cause the vehicle 100 to run by unmanned driving, the captured image in which the vehicle 100 is imaged is input into a detection model DM, which is a trained machine learning model, to detect the external shape of the vehicle 100 from the captured image, and thus the vehicle position information is acquired. This detection model DM may have been trained by using training images in which the vehicle 100 in a normal running state, that is, the vehicle 100 with the equipment 140 whose open-close state is the close state is imaged. In this case, when the open-close state of the equipment 140 having an effect on the external shape of the vehicle 100 is kept the open state even after accomplishment of the specific purpose, the external shape of the vehicle 100 differs from that in the training of the detection model DM, and thereby it may be impossible to recognize the external shape of the vehicle 100 and to acquire the vehicle position information. Accordingly, the vehicle 100 may not be able to continue running by unmanned driving. In contrast, according to the first embodiment, when it is predicted that the vehicle 100 will have a trouble with running by unmanned driving due to the open-close state of the equipment 140 being the open state, the control system 50 can execute processing to eliminate the trouble. In such an embodiment, it is possible to avoid a situation in which the vehicle position information cannot be acquired since the external shape of the vehicle 100 differs from that in the training of the detection model DM. This allows to avoid a situation in which the vehicle 100 cannot continue running by unmanned driving since the vehicle position information cannot be acquired. In this way, the open-close state of the equipment 140 is kept the open state even after accomplishment of the specific purpose, so that the control system 50 can reduce a possibility that the vehicle 100 has a trouble with running by unmanned driving.

In particular, in a case in which the vehicle 100 runs by unmanned driving and the vehicle 100 does not have an occupant, it may be unrecognizable that the open-close state of the equipment 140 is kept the open state even after accomplishment of the specific purpose. In contrast, according to the first embodiment, the control system 50 can execute the specific processing to eliminate a trouble by remote control. Therefore, even when the vehicle 100 does not have an occupant, the vehicle 100 can have a reduced possibility of having a trouble with running by unmanned driving.

Moreover, according to the first embodiment, the equipment 140 may be a component, such as a hood, whose open-close state is changeable by mechanical manipulation. The open-close state of the equipment 140 whose open-close state is changeable by mechanical manipulation may be undetectable by utilizing only communication within the vehicle 100, such as CAN (controller area network) communication. In contrast, according to the first embodiment, the control system 50 can detect the open-close state of the equipment 140 from outside of the vehicle 100 by using the sensor without utilizing the communication within the vehicle 100. In such an embodiment, even when the open-close state of the equipment 140 whose open-close state is undetectable by utilizing only the communication within the vehicle 100 is the open state, the vehicle 100 can have a reduced possibility of having a trouble with running by unmanned driving.

Moreover, in the first embodiment, the equipment 140 may be a component, such as a power door, an electric trunk lid, an electric roof, a fuel lid, or a charging lid, whose open-close state is detectable by utilizing only communication within the vehicle 100. Also in such an embodiment, the control system 50 can detect the open-close state of the equipment 140 from outside of the vehicle 100 by using the sensor. Accordingly, even when the communication within the vehicle 100 cannot be utilized or the communication within the vehicle 100 has a malfunction since the vehicle 100 is in the middle of production, the vehicle 100 can have a reduced possibility of having a trouble with running by unmanned driving. Note that the control system 50 may further utilize the communication within the vehicle 100 to detect the open-close state of the equipment 140. In such an embodiment, the detection result of the sensor and the communication within the vehicle 100 can be utilized to more precisely detect the open-close state of the equipment 140. Accordingly, the vehicle 100 can have a further reduced possibility of having a trouble with running by unmanned driving.

Moreover, according to the first embodiment, the control system 50 can execute, as the specific processing, the notification processing to notify the user U of the error information. In such an embodiment, the control system 50 notifies the user U of the error information to encourage the user U to change the open-close state of the equipment 140. Therefore, the open-close state of the equipment 140 can be changed from the open state to the close state manually by the user U. Accordingly, even when the open-close state of the equipment 140 whose open-close state cannot be changed through electric control from outside is the open state, the vehicle 100 can have a reduced possibility of having a trouble with running by unmanned driving.

Moreover, according to the first embodiment, the control system 50 is used in the factory FC where the vehicle 100 is produced. In the factory FC where the vehicle 100 is produced, a work content is determined in advance per production step, and an appropriate open-close state of the equipment 140 is different depending on the work content. Thus, the appropriate open-close state of the equipment 140 in each production step can be made into a database in advance. In the first embodiment, with this database, the control system 50 refers to the first database indicating for each production step whether the vehicle 100 will have a trouble with running by unmanned driving, and predicts based on the step information whether the vehicle 100 will have a trouble with running by unmanned driving. In such an embodiment, the control system 50 can predict, in accordance with the production step, whether the vehicle 100 will have a trouble with running by unmanned driving due to the open-close state of the equipment 140 being the open state.

### B. Second Embodiment:

In this embodiment, when the prediction unit 213 predicts that the vehicle 100 will have a trouble with running by unmanned driving due to the open-close state of the equipment 140 being the open state, the remote control unit 214 operates as follows. The remote control unit 214 controls the open-close state of the equipment 140, such as a power door, an electric trunk lid, an electric roof, a fuel lid, or a charging lid, whose open-close state can be changed through electric control from outside, so that the open-close state of the equipment 140 becomes the close state. That is, the remote control unit 214 executes, as the specific processing, changing processing to change the open-close state of the equipment 140 from the open state to the close state. In the changing processing, the remote control unit 214 generates an equipment control signal and transmits to the vehicle 100 the equipment control signal. The equipment control signal is a control signal to change the open-close state of the equipment 140. Accordingly, the remote control unit 214 changes the open-close state of the equipment 140 from the open state to the close state by remote control.

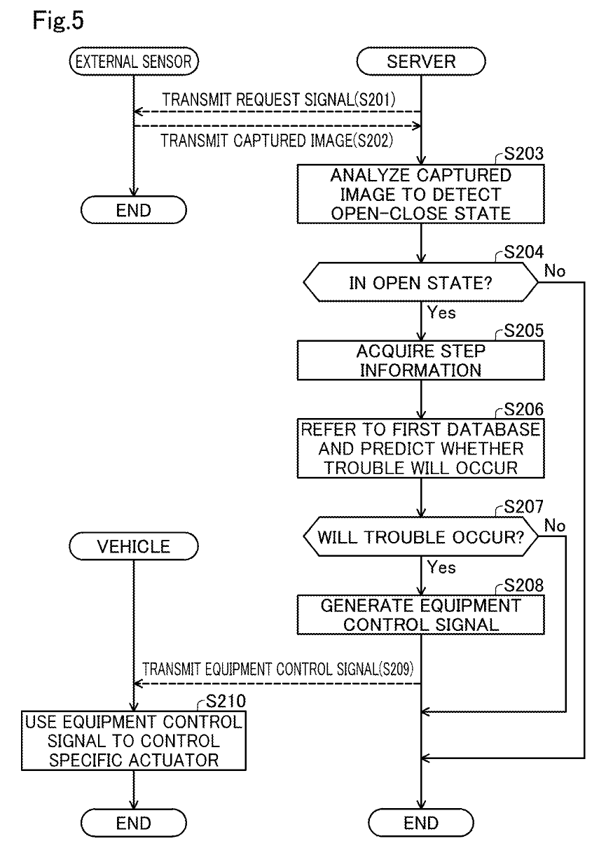

FIG. 5 is a flowchart illustrating a control method according to a second embodiment. At Step S201, the acquisition unit 211 of the server 200 transmits to the camera as the external sensor 300 the request signal to acquire the captured image. In response to reception of the request signal, at Step S202, the external sensor 300 transmits to the server 200 the captured image in which the vehicle 100 is imaged. When the acquisition unit 211 of the server 200 acquires the captured image, at Step S203, the detection unit 212 of the server 200 analyzes the captured image to detect the open-close state of the equipment 140. If the detection unit 212 detects that the open-close state of the equipment 140 is the close state (Step S204: No), the server 200 ends this flow. If the detection unit 212 detects that the open-close state of the equipment 140 is the open state (Step S204: Yes), at Step S205, the acquisition unit 211 of the server 200 uses the vehicle position information to acquire the step information. At Step S206, the prediction unit 213 of the server 200 refers to the first database DB and predicts based on the step information whether the vehicle 100 will have a trouble with running by unmanned driving. If the prediction unit 213 predicts that the vehicle 100 will not have a trouble with running by unmanned driving (Step S207: No), the server 200 ends this flow. If the prediction unit 213 predicts that the vehicle 100 will have a trouble with running by unmanned driving (Step S207: Yes), at Step S208, the remote control unit 214 of the server 200 generates the equipment control signal to change the open-close state of the equipment 140 from the open state to the close state. At Step S209, the remote control unit 214 transmits the generated equipment control signal to the vehicle 100. In response to reception of the equipment control signal, at Step S210, the vehicle control unit 115 of the vehicle 100 uses the received equipment control signal to control the specific actuator, and thus changes the open-close state of the equipment 140 from the open state to the close state.

According to the second embodiment, the control system 50 can execute, as the specific processing, the changing processing to change the open-close state of the equipment 140 from the open state to the close state. In such an embodiment, when occurrence of a trouble is predicted, the control system 50 can automatically change the open-close state of the equipment 140 from the open state to the close state. Accordingly, the vehicle 100 can have a reduced possibility of having a trouble with running by unmanned driving.

Moreover, according to the second embodiment, the control system 50 can automatically change the open-close state of the equipment 140 from the open state to the close state without the user U manually changing the open-close state of the equipment 140. This can reduce a work load of the user U.

### C. Third Embodiment:

In the control system 50 of this embodiment, when the prediction unit 213 predicts that the vehicle 100 will have a trouble with running by unmanned driving due to the open-close state of the equipment 140 being the open state, the remote control unit 214 stops the vehicle 100. That is, the remote control unit 214 executes, as the specific processing, stopping processing to stop the vehicle 100. In the stopping processing, the remote control unit 214 generates a stop control signal and transmits the stop control signal to the vehicle 100. The stop control signal is a control signal to stop the vehicle 100. This allows the remote control unit 214 to stop the vehicle 100 by remote control.

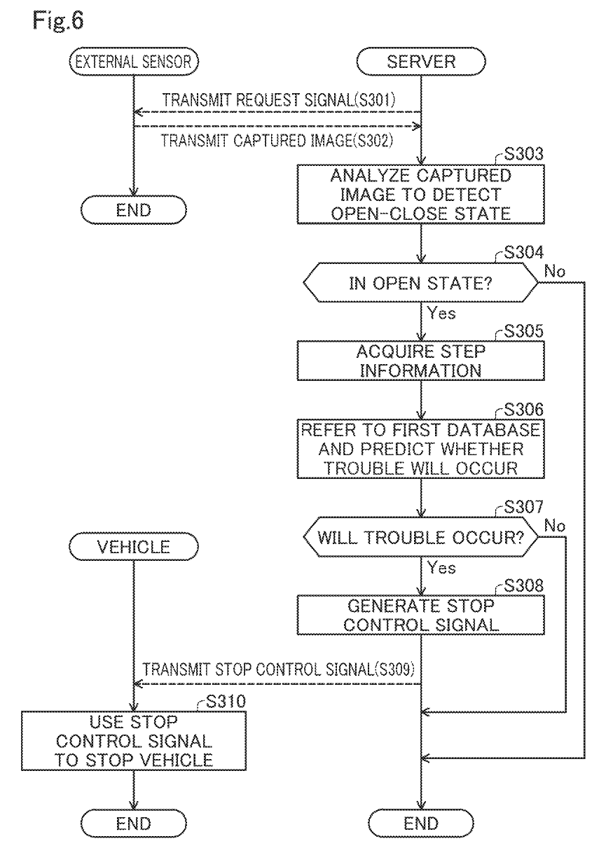

FIG. 6 is a flowchart illustrating a control method according to a third embodiment. At Step S301, the acquisition unit 211 of the server 200 transmits to the camera as the external sensor 300 the request signal to acquire the captured image. In response to reception of the request signal, at Step S302, the external sensor 300 transmits to the server 200 the captured image in which the vehicle 100 is imaged. When the acquisition unit 211 of the server 200 acquires the captured image, at Step S303, the detection unit 212 of the server 200 analyzes the captured image to detect the open-close state of the equipment 140. If the detection unit 212 detects that the open-close state of the equipment 140 is the close state (Step S304: No), the server 200 ends this flow. If the detection unit 212 detects that the open-close state of the equipment 140 is the open state (Step S304: Yes), at Step S305, the acquisition unit 211 of the server 200 uses the vehicle position information to acquire the step information. At Step S306, the prediction unit 213 of the server 200 refers to the first database DB and predicts based on the step information whether the vehicle 100 will have a trouble with running by unmanned driving. If the prediction unit 213 predicts that the vehicle 100 will not have a trouble with running by unmanned driving (Step S307: No), the server 200 ends this flow. If the prediction unit 213 predicts that the vehicle 100 will have a trouble with running by unmanned driving (Step S307: Yes), at Step S308, the remote control unit 214 of the server 200 generates the stop control signal. At Step S309, the remote control unit 214 transmits the generated stop control signal to the vehicle 100. In response to reception of the stop control signal, at Step S310, the vehicle control unit 115 of the vehicle 100 uses the received stop control signal to control the actuator group 120, and thus stops the vehicle 100.

According to the third embodiment, the control system 50 can execute the stopping processing to stop the vehicle 100 as the specific processing. In such an embodiment, when occurrence of a trouble is predicted, the control system 50 can stop the vehicle 100. This allows to secure time to change the open-close state of the equipment 140 from the open state to the close state. Accordingly, the vehicle 100 can have a reduced possibility of having a trouble with running by unmanned driving.

### D. Fourth Embodiment:

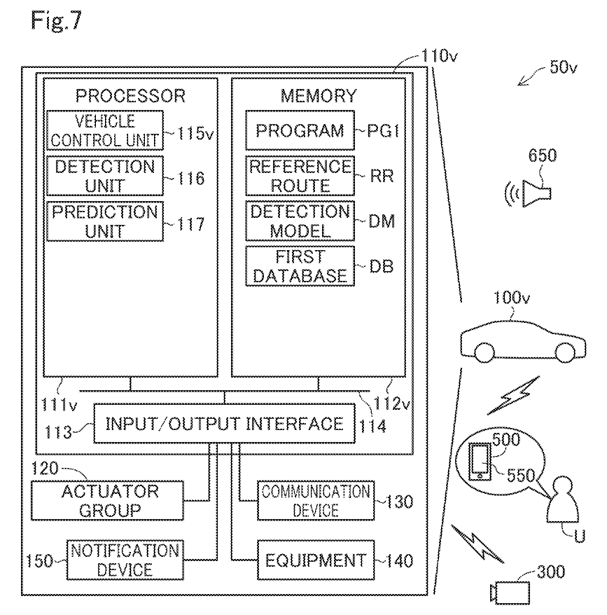

FIG. 7 is an explanatory diagram illustrating a schematic configuration of a control system 50v according to a fourth embodiment. This embodiment is different from the first embodiment in that the control system 50v does not include the server 200. Moreover, a vehicle 100v of this embodiment is runnable by autonomous control of the vehicle 100v. Other configurations are the same as those of the first embodiment unless otherwise described.

In this embodiment, a processor 111v of a vehicle control device 110v executes the program PG1 stored in a memory 112v, thus functioning as a vehicle control unit 115v, a detection unit 116, and a prediction unit 117. The detection unit 116 uses the detection result of the sensor to detect the open-close state of the equipment 140. When the detection unit 116 detects that the open-close state of the equipment 140 is the open state, the prediction unit 117 predicts whether the vehicle 100v will have a trouble with running by unmanned driving due to the open-close state of the equipment 140 being the open state. The vehicle control unit 115v acquires the output result of the sensor and uses the output result to generate the running control signal. The vehicle control unit 115v then outputs the generated running control signal to operate the actuator group 120, allowing the vehicle 100v to run by autonomous control. In this embodiment, the memory 112v stores, in addition to the program PG1, the detection model DM and a reference route RR in advance. Further, when the prediction unit 117 predicts that the vehicle 100v will have a trouble with running by unmanned driving, the vehicle control unit 115v executes the specific processing.

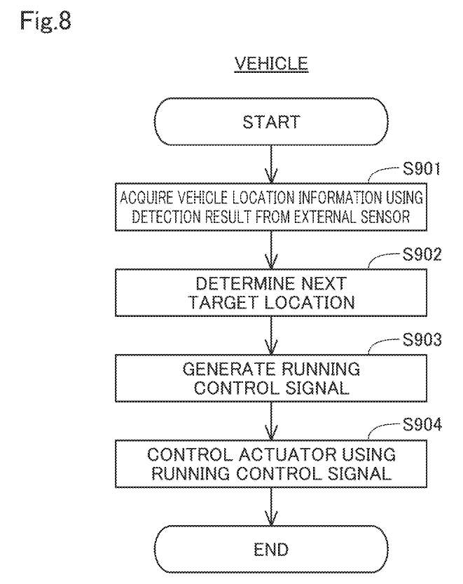

FIG. 8 is a flowchart showing a processing procedure for running control of the vehicle 100v In step S901, the processor 111v of the vehicle control device 110v acquires vehicle location information using detection result output from the camera as an external sensor 300. In step S902, the processor 111v determines a target location to which the vehicle 100v is to move next. In step S903, the processor 111v generates a running control signal for causing the vehicle 100v to run to the determined target location. In step S904, the processor 111v controls the actuator group 120 using the generated running control signal, thereby causing the vehicle 100v to run by following a parameter indicated by the running control signal. The processor 111v repeats the acquisition of vehicle location information, the determination of a target location, the generation of a running control signal, and the control over the actuator in a predetermined cycle. According to the control system 50v in the present embodiment, it is possible to cause the vehicle 100v to run by autonomous control without controlling the vehicle 100v remotely using the server 200.

According to the fourth embodiment, the control system 50v can execute the specific processing to eliminate a trouble by autonomous control of the vehicle 100v.

### E. Other Embodiments:

(E1) In each of the embodiments described above, a detection result output from an internal sensor may be used for at least one of generating a route and generating the running control signal. In this case, when the open-close state of the equipment 140 having an effect on the external shape of the vehicle 100, 100v is kept the open state even after accomplishment of the specific purpose, an environment around the vehicle 100, 100v may be unrecognizable due to the equipment 140 interrupting a detection range of the internal sensor. As a result, the vehicle 100, 100v may not be able to continue running by unmanned driving since an obstacle present around the vehicle 100, 100v cannot be detected or the vehicle position information cannot be acquired. Also in such a case, execution of processing to eliminate a trouble allows the vehicle 100, 100v to have a reduced possibility of having a trouble with running by unmanned driving.

(E2) In each of the embodiments described above, the equipment 140 may be a fuel lid or a charging lid, or may be a component, such as a supply-port cap, other than the component having an effect on the external shape of the vehicle 100, 100v. In such an embodiment, the vehicle 100, 100v can have a reduced possibility of running while the open-close state of the fuel lid, the charging lid, or the supply-port cap is the open state. This can reduce a possibility that fuel leaks out from a supply port during running, or a charging plug gets wet and damaged due to rain or snow, or liquid, such as cleaning solution during car wash. Thereby, the vehicle 100, 100v can have a reduced possibility of having a trouble with running by unmanned driving.

(E3) In each of the embodiments described above, the equipment 140 may be a component, such as a door, a trunk lid, a window, or a roof, that partitions an inside and an outside of a cabin or luggage compartment. In such an embodiment, the vehicle 100, 100v can have a reduced possibility of running while the open-close state of the equipment 140 is the open state. This can reduce a possibility that an occupant or luggage is thrown out of the vehicle 100, 100v, the equipment 140 contacts another object, or the inside of the cabin or luggage compartment is soaked with water. Thereby, the vehicle 100, 100v can have a reduced possibility of having a trouble with running by unmanned driving.

(E4) When the vehicle 100, 100v is used, in ordinary operation, such as getting on or off or power source refilling with respect to the vehicle 100, 100v, as well as in non-ordinary operation, such as inspection or repair, the open-close state of the equipment 140 may be made the open state in order to accomplish the specific purpose. For example, in order to get on or off the vehicle 100, 100v, a boarding door may be opened. In order to load luggage onto a luggage compartment, a luggage compartment door or a trunk lid may be opened. In order for ventilation, a window may be opened. In order to refill a power source of the vehicle 100, 100v, a fuel lid, a charging lid, or a supply-port cap may be opened. In order for inspection or repair, a hood may be opened. Also in such a case, the open-close state of the equipment 140 may be kept the open state even after accomplishment of the specific purpose. Thus, in each of the embodiments described above, the control system 50, 50v may be used other than in the factory FC where the vehicle 100, 100v is produced. That is, the control system 50, 50v may eliminate a trouble that may occur when the vehicle 100, 100v after shipment runs by unmanned driving. The control system 50, 50v may be used in an urban area, and for example, the vehicle 100, 100v may be used at a vehicle inspection site where the vehicle 100, 100v is inspected, a repair site where the vehicle 100, 100v is repaired, a gas station, hydrogen filling station, or a charging station where a power source of the vehicle 100, 100v is refilled. In the case in which the control system 50, 50v is used other than in the factory FC, the expression "factory" in the present disclosure can appropriately be replaced by any place as described above, and the expression "production" can appropriately be replaced by "work" or "operation". In such an embodiment, the control system 50, 50v can reduce a possibility that the vehicle 100, 100v has a trouble with running by unmanned driving other than in the factory FC.

(E5) The appropriate open-close state of the equipment 140 may be different depending on a driving state of the vehicle 100, 100v, including a running state, a temporarily stopping state, and a parking state. For example, when the driving state of the vehicle 100, 100v is the running state, or in the temporarily stopping state for waiting at a traffic light or the like, a window, a roof, or the like may be in the open state, but a door, a trunk lid, or the like is preferably in the close state. On the other hand, when the driving state of the vehicle 100, 100v is in the parking state, in order to get on or off or to load or unload luggage with respect to the vehicle 100, 100v, to refill fuel, or the like, a door, a trunk lid, a supply-port cap, a fuel lid, a charging lid, or the like may preferably be in the open state. With respect to this, in each of the embodiments described above, the control system 50, 50v may utilize the driving state of the vehicle 100, 100v to predict whether the vehicle 100, 100v will have a trouble with running by unmanned driving. In this case, the acquisition unit 211 acquires drive information indicating the driving state of the vehicle 100, 100v. For example, the drive information is information indicating a gear shift position of the vehicle 100, 100v. The drive information may be information indicating a transmission history of the running control signal, a positional change of the vehicle 100, 100v over predetermined time, stopping time of the vehicle 100, 100v, or speed or acceleration of the vehicle 100, 100v. The prediction unit 117, 213 refers to a second database (not illustrated) stored in the memory 112v, 202 in advance and indicating for each driving state of the vehicle 100, 100v whether the vehicle 100, 100v will have a trouble with running by unmanned driving. Then, the prediction unit 117, 213 identifies presence or absence of a trouble, which is associated with the driving state of the vehicle 100, 100v identified by the drive information, and thus predicts whether the vehicle 100, 100v will have a trouble with running by unmanned driving. In such an embodiment, the control system 50, 50v can predict whether the vehicle 100, 100v will have a trouble with running by unmanned driving due to the open-close state of the equipment 140 being the open state in accordance with the driving state of the vehicle 100, 100v. Further, in such an embodiment, whether the vehicle 100, 100v will have a trouble with running by unmanned driving due to the open-close state of the equipment 140 being the open state can be predicted without using the step information. Therefore, the control system 50, 50v is applicable in a wider range.

(E6) In each of the embodiments described above, the control system 50, 50v may execute, as the specific processing, processing other than the stopping processing, the notification processing, and the changing processing, or execute two or more kinds of processing. For example, the control system 50, 50v may execute the stopping processing when the open-close state of the equipment 140 is the open state even after execution of the notification processing or the changing processing. In such an embodiment, while the vehicle 100, 100v has a reduced possibility of having a trouble with running by unmanned driving, disruption of production of the vehicle 100, 100v due to stopping of the vehicle 100, 100v can be avoided.

(E7) In each of the above-described embodiments, the external sensor 300 is not limited to the camera but may be the distance measuring device, for example. The distance measuring device is a light detection and ranging (LiDAR) device, for example. In this case, detection result output from the external sensor 300 may be three-dimensional point cloud data representing the vehicle 100, 100v. The server 200 and the vehicle 100, 100v may acquire the vehicle location information through template matching using the three-dimensional point cloud data as the detection result and reference point cloud data, for example.

(E8) In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control the actuator group 120 using the generated running control signal.

(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(E9) In the above-described fourth embodiment, the vehicle 100v may be equipped with an internal sensor, and detection result output from the internal sensor may be used in at least one of generation of a route and generation of a running control signal. For example, the vehicle 100v may acquire detection result from the internal sensor, and in generating the route, may reflect the detection result from the internal sensor in the route. The vehicle 100v may acquire detection result from the internal sensor, and in generating the running control signal, may reflect the detection result from the internal sensor in the running control signal.

(E10) In the above-described fourth embodiment, the vehicle 100v acquires vehicle location information using detection result from the external sensor. By contrast, the vehicle 100v may be equipped with an internal sensor, the vehicle 100 may acquire vehicle location information using detection result from the internal sensor, determine a target location to which the vehicle 100v is to move next, generate a route from a current location of the vehicle 100 indicated by the acquired vehicle location information to the target location, generate a running control signal for running along the generated route, and control the actuator group 120 of the vehicle 100v using the generated running control signal. In this case, the vehicle 100v is capable of running without using any detection result from the external sensor 300. The vehicle 100v may acquire target arrival time or traffic congestion information from outside the vehicle 100v and reflect the target arrival time or traffic congestion information in at least one of the route and the running control signal. The functional configuration of the control system 50v may be entirely provided at the vehicle 100v. Specifically, the processes realized by the control system 50v in the present disclosure may be realized by the vehicle 100v alone.

(E11) In the above-described first embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device.

(E12) In each of the above-described embodiments, the vehicle 100,100v is simply required to have a configuration to become movable by unmanned driving. The vehicle 100,100v may embodied as a platform having the following configuration, for example. The vehicle 100,100v is simply required to include at least the vehicle control device 110,110v and the actuator group 120. In order for the vehicle 100,100v to acquire information from outside for unmanned driving, the vehicle 100,100v is simply required to include the communication device 130 further. Specifically, the vehicle 100,100v to become movable by unmanned driving is not required to be equipped with at least some of interior components such as a driver’s seat and a dashboard, is not required to be equipped with at least some of exterior components such as a bumper and a fender or is not required to be equipped with a bodyshell. In such cases, a remaining component such as a bodyshell may be mounted on the vehicle 100,100v before the vehicle 100,100v is shipped from a factory, or a remaining component such as a bodyshell may be mounted on the vehicle 100,100v after the vehicle 100,100v is shipped from the factory FC while the remaining component such as a bodyshell is not mounted on the vehicle 100,100v. Each of components may be mounted on the vehicle 100,100v from any direction such as from above, from below, from the front, from the back, from the right, or from the left. Alternatively, these components may be mounted from the same direction or from respective different directions. The location determination for the platform may be performed in the same way as for the vehicle 100,100v in the first embodiments.

(E13) The vehicle 100,100v may be manufactured by combining a plurality of modules. The module means a unit composed of one or more components grouped according to a configuration or function of the vehicle 100,100v. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100,100v different from the platform may be modularized. Various modules may include an arbitrary exterior component such as a bumper or a grill, or an arbitrary interior component such as a seat or a console. Not only the vehicle 100,100v but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(E14) A configuration for realizing running of the vehicle 100,100v by unmanned driving is also called a "Remote Control auto Driving system". Conveying the vehicle 100,100v using Remote Control Auto Driving system is also called "self-running conveyance". Producing the vehicle 100,100v using self-running conveyance is also called "self-running production". In self-running production, for example, at least part of the conveyance of the vehicle 100,100v is realized by self-running conveyance in the factory FC where the vehicle 100,100v is manufactured.

The present disclosure is not limited to the above-described embodiments but can be implemented in a variety of configurations without departing from the spirit of the present disclosure. For example, in order to solve some or all of the aforementioned problems or to achieve some or all of the aforementioned effects, the technical features of the embodiment corresponding to the technical features in each aspect described in the summary can appropriately be replaced or combined. Moreover, unless the technical feature is explained herein as being essential, it can be eliminated as appropriate. The present disclosure may be implemented by aspects described below.

(1) According to one aspect of the present disclosure, a control system is provided. In a control system that controls an open-close state of equipment whose open-close state is changeable, the equipment is installed to a moving object that is movable by unmanned driving. The control system includes a sensor, a detection unit, a prediction unit, and a control unit. The sensor detects an external shape of the moving object from outside of the moving object. The detection unit uses a detection result of the sensor to detect the open-close state of the equipment. When the detection unit detects that the open-close state of the equipment is an open state, the prediction unit predicts whether the moving object will have a trouble with moving by the unmanned driving due to the open-close state of the equipment being the open state. When the prediction unit predicts that the trouble occurs, the control unit executes specific processing to eliminate the trouble. According to this aspect, the open-close state of the equipment is kept the open state even after accomplishment of a specific purpose, so that the moving object can have a reduced possibility of having a trouble with moving by unmanned driving.

(2) In the above-described aspect, the equipment may be a component whose open-close state is undetectable by utilizing communication within the moving object. According to this aspect, the open-close state of the equipment can be detected from outside of the moving object by using the sensor without utilizing the communication within the moving object. Accordingly, even in the case in which the equipment is the component whose open-close state is undetectable by utilizing the communication within the moving object, the moving object can have a reduced possibility of having a trouble with moving by unmanned driving.

(3) In the above-described aspect, the control unit may execute, as the specific processing, at least one of stopping processing to stop the moving object, notification processing to notify a user of error information indicating that occurrence of the trouble is predicted, and changing processing to change the open-close state of the equipment from the open state to a close state. According to this aspect, when occurrence of a trouble is predicted, the moving object is stopped, and thus time to change the open-close state of the equipment from the open state to the close state can be secured. Accordingly, the moving object can have a reduced possibility of having a trouble with moving by unmanned driving. Moreover, according to this aspect, when occurrence of a trouble is predicted, the user can be notified of the error information and encouraged to change the open-close state of the equipment. Therefore, the open-close state of the equipment can be changed from the open state to the close state manually by the user. Accordingly, even when the open-close state of the equipment whose open-close state cannot be changed through electric control from outside is the open state, the moving object can have a reduced possibility of having a trouble with moving by unmanned driving. Moreover, according to this aspect, when occurrence of a trouble is predicted, the open-close state of the equipment can automatically be changed from the open state to the close state. Accordingly, while the moving object can have a reduced possibility of having a trouble with moving by unmanned driving, a work load of a user U can be reduced.

(4) In the above-described aspect, an acquisition unit and a memory may further be included. The acquisition unit may acquire step information indicating a work step executed to the moving object. The memory may store a first database indicating for each work step whether the trouble will occur. The prediction unit may refer to the first database and identify presence or absence of the trouble to predict whether the trouble will occur, the presence or absence of the trouble being associated with the work step identified by the step information. According to this aspect, whether a trouble will occur can be predicted in accordance with the work step.

(5) In the above-described aspect, an acquisition unit and a memory may further be included. The acquisition unit may acquire drive information indicating a driving state of the moving object. The memory may store a second database indicating for each driving state whether the trouble will occur. The prediction unit may refer to the second database and identify presence or absence of the trouble to predict whether the trouble will occur, the presence or absence of the trouble being associated with the driving state of the moving object identified by the drive information. According to this aspect, whether a trouble will occur can be predicted in accordance with the driving state of the moving object.

The present disclosure can be implemented in various aspects other than the control system described above. For example, the present disclosure can be implemented in aspects, such as a moving object or a server that can implement at least some of functions of a control system, a method for controlling equipment or a vehicle by a control system, a computer program that implements the control method, and a non-transitory recording medium recording the computer program.

What is claimed is:

1. A control system configured to control an open-close state of equipment whose open-close state is changeable, wherein
the equipment is installed to a moving object that is movable by unmanned driving, and
the control system comprises:
a sensor configured to detect an external shape of the moving object from outside of the moving object;
a detection unit configured to use a detection result of the sensor to detect the open-close state of the equipment;
a prediction unit configured to, when the detection unit detects that the open-close state of the equipment is an open state, predict whether the moving object will have a trouble with moving by the unmanned driving due to the open-close state of the equipment being the open state; and
a control unit configured to, when the prediction unit predicts that the trouble occurs, execute specific processing to eliminate the trouble.

2. The control system according to claim 1, wherein the equipment is a component whose open-close state is undetectable by utilizing communication within the moving object.

3. The control system according to claim 1, wherein the control unit executes, as the specific processing, at least one of stopping processing to stop the moving object, notification processing to notify a user of error information indicating that occurrence of the trouble is predicted, and changing processing to change the open-close state of the equipment from the open state to a close state.

4. The control system according to claim 1, further comprising:
an acquisition unit configured to acquire step information indicating a work step executed to the moving object; and
a memory storing a first database indicating for each work step whether the trouble will occur, wherein
the prediction unit refers to the first database and identifies presence or absence of the trouble to predict whether the trouble will occur, the presence or absence of the trouble being associated with the work step identified by the step information.

5. The control system according to claim 1, further comprising:
an acquisition unit configured to acquire drive information indicating a driving state of the moving object; and
a memory storing a second database indicating for each driving state whether the trouble will occur, wherein
the prediction unit refers to the second database and identifies presence or absence of the trouble to predict whether the trouble will occur, the presence or absence of the trouble being associated with the driving state of the moving object identified by the drive information.
